(19) United States
(12) Patent Application Publication
(10) Pub. No.: US 2021/0204702 A1
(43) Pub. Date: Jul. 8, 2021

(54) RESISTIVE SUPPORT MECHANISM

(71) Applicant: CORECHAIR INCORPORATED, Aurora (CA)

(72) Inventor: Patrick HARRISON, Aurora (CA)

(21) Appl. No.: 17/258,766

(22) PCT Filed: Jul. 12, 2019
(86) PCT No.: PCT/CA2019/050966

§ 371 Date: Jan. 8, 2021

Related U.S. Application Data
(60) Provisional application No. 62/697,357, filed on Jul. 12, 2018.

(51) Int. Cl. A47C 7/56; A47C 7/58; A47C 7/60

(52) U.S. Cl. CPC A47C 7/566; A47C 7/60; A47C 7/563; A47C 7/58

(57) ABSTRACT

A resistive motion support mechanism joined to a mounting surface and to a base shaft for providing resistive support to the mounting surface as the mounting surface undergoes one or both of rotational and tilt movement relative to the base, the motion support mechanism including a support bearing connected to the mounting surface and to the base shaft which permits one or both of tilting and rotational motion of the mounting surface relative to the base; a pivot ball functionally attached to a portion of the base shaft; a resilient ring within a housing circumscribing the base shaft such that the resilient member is compressed between the housing and the base shaft by the relative movement between the base shaft and the mounting surface to provide a resistive force on the base shaft to resist the one or both of rotational and tilt movement; and, various means for varying the resistive force.

### FIELD OF THE INVENTION

The present invention relates generally to the field of support mechanisms for chairs and other human-supporting devices, and more particularly to a resistive support mechanism for use in a chair capable of providing feedback to a user regarding their activity level while seated.

### BACKGROUND OF THE INVENTION

Conventional motion mechanisms used in most applications such as office chairs, usually incorporate the use of various options for adjusting the tilt on the chairs or restricting the motion of the chair. There are many examples of prior art with respect to what are known as ergonomic chairs which can be adjusted to the individuals body dimensions with the specific aim of restricting movement. For individuals with repetitive motion injuries this approach is quite logical but for those who wish to both vary their movements while working and who actually embrace more activity in the workplace without having to stand, an active chair that doesn't restrict motion is required. The objective of a chair such as an active motion chair is to improve the core strength of the user as opposed to support repetitive stress injuries. We see in various prior art examples, devices that are generally restrictive in their range of motion and to a large extent designed to render the user motionless as opposed to allowing free flowing movement. These mechanisms are not readily adaptable to different tasks that the user may undertake. Prior art devices are generally restrictive in the range of motion, tilt from a fulcrum well below the upper surface, use springs, are not readily adaptable and tend to be expensive and so out of reach for the average consumer. The representative state of the art device is disclosed in U.S. Pat. No. 9,211,013 to the applicant, CoreCair Incorporated. The present disclosure is an improvement on the aforementioned patent, and applicable to motion mechanisms in general.

### SUMMARY OF THE INVENTION

According to one embodiment of the invention, there is provided a resistive motion support mechanism joined to a mounting surface and to a base shaft for providing resistive support to the mounting surface as the mounting surface undergoes one or both of rotational and tilt movement relative to the base, the motion support mechanism comprising: a support bearing connected to the mounting surface and to the base shaft which permits one or both of tilting and rotational motion of the mounting surface relative to the base; a pivot ball functionally attached to a portion of the base shaft; a resilient ring within a housing circumscribing the base shaft such that the resilient member is compressed between the housing and the base shaft by the relative movement between the base shaft and the mounting surface to provide a resistive force on the base shaft to resist the one or both of rotational and tilt movement; and, a means for varying the resistive force by imparting a force onto the resilient ring thereby changing its resiliency.

In one aspect of the invention, the mounting surface is moveable from an uppermost to a lowermost positions; and the means for varying the resistive force includes at least one spacer extending from an underside of the mounting surface to an upper surface of the resilient ring such that at the uppermost position the spacer applies a minimum force on the resilient ring and at the lowermost position, the spacer applies a maximum force on the resilient ring.

In one aspect of the invention, the minimum force is no force.

In one aspect of the invention, there is further provided a second spacer extending from a lower surface of the resilient ring to a base surface of the housing.

In one aspect of the invention, the resilient ring comprises a plurality of internal deformation gaps where material is removed from the resilient ring to facilitate compression of the resilient ring towards the base shaft.

In one aspect of the invention, the resilient ring comprises a material selected from the group comprising an elastomer, a silicone, a dampening gel, a viscoelastomer, a bonded dampening material and a combination of same.

In one aspect of the invention, resilient member is adapted to bias the mounting surface to a home position.

In one aspect of the invention, there is further provided a rigid plate connected proximate to an underside of the resilient member, wherein the rigid plate has a surface having a plurality of locking elements on a surface distal to the resilient member, and wherein the means for locking comprises a locking pad having a surface of complimentary locking elements adapted to be brought into contact with the plurality of locking elements on the rigid plate.

In another embodiment of the invention, there is provided a chair comprising the resistive support mechanism of any one of claims 1 to 8.

In another embodiment of the invention, there is provided a method for varying the resistance in a resistive motion support mechanism, the resistive motion support mechanism including a resilient ring within a housing circumscribing a base shaft such that the resilient member is compressed between the housing and the base shaft by the relative movement between the base shaft and a mounting surface to provide a resistive force on the base shaft to resist one or both of rotational and tilt movement; the method comprising imparting a force onto the resilient ring thereby changing its resiliency.

In one aspect of the invention, imparting a force comprises moving a mounting surface from an uppermost to a lowermost position, such that the movement of the mounting surface applies a force onto a spacer which compresses the resilient ring.

In one aspect of the invention, the spacer extends from an underside of the mounting surface to an upper surface of the resilient ring such that at the uppermost position the spacer applies a minimum force on the resilient ring and at the lowermost position, the spacer applies a maximum force on the resilient ring.

In one aspect of the invention, the minimum force is no force.

In one aspect of the invention, the resilient ring comprises a plurality of internal deformation gaps where material is removed from the resilient ring to facilitate compression of the resilient ring towards the base shaft.

In one aspect of the invention, the resilient ring comprises a material selected from the group comprising an elastomer, a silicone, a dampening gel, a viscoelastomer, a bonded dampening material and a combination of same.

### BRIEF DESCRIPTION OF THE DRAWINGS

Embodiments will now be described, by way of example only, with reference to the attached Figures, wherein:

FIG. 1 shows a user sitting on a chair incorporating the resistive motion support mechanism.

FIGS. 2A and 2B are top and sectional views, respectively of the resistive motion support mechanism.

FIGS. 3A and 3B are sectional and side views, respectively illustrating a resistance varying means.

FIGS. 4A and 4B are sectional and side views, respectively illustrating a resistance varying means.

FIGS. 5A and 5B are top and sectional views, respectively illustrating a locking means.

FIGS. 6A and 6B are detail views showing a portion of FIG. 5B when the locking means is in the locked and unlocked position, respectively.

FIGS. 7A and 7B are sectional views of an alternative locking means in the unlocked and locked position, respectively.

FIG. 8 is a perspective view of another resistive support mechanism.

FIGS. 9A and 9B are top and sectional views of the mechanism of FIG. 8.

FIGS. 10A, 10B, and 10C are top, sectional and exploded views, respectively that includes a height adjustment means.

FIG. 11 is a detail view of elements of the locking means of FIG. 5.

FIG. 12 is a sectional view of an improved resistive motion support mechanism according to the present invention.

### DETAILED DESCRIPTION OF THE EMBODIMENTS

This invention relates to a novel system for an active motion and support mechanism, that could be used in a chair for example, that provides for both three hundred and sixty degree (360°) resistive support in a tilting motion and rotational movement. Particularly, this invention relates to a mechanism that incorporates a bushing comprised of a resilient material that is in contact with a base element, a shaft and a housing such that it can be compressed and decompressed by the user to provide resistive support during the tilting motion. More particularly, such as in one aspect of the invention when used as a swivel chair mechanism, the invention is a system that enables the user to actively engage in many movements that a standard swivel chair could not accommodate thus aiding in the effort to address what is known as sitting disease. Another embodiment of this invention would allow the mechanism to be locked into various positions. Additional features can be added to allow for tension adjustments and attachments to allow for activation of external features such as height adjustments. Specifically, the invention relates to a novel mechanism that includes a resistive resilient bushing that in one aspect is incorporated into a housing with the resilient member in contact with both the housing, a shaft and a base element. In another aspect of the invention the bushing may include an upper and lower plate that can be brought into contact with the tilting portion of the mechanism to lock it into position. In yet another aspect, the invention also further provides the ability to adjust the resistance by compressing the bushing by drawing the upper and lower plates closer together or strategically positioning the bushing within the housing to a preferred resistance. In another aspect of the invention the resistance can be adjusted by simply using either differing resilient materials or similar materials with differing durometer attributes for the bushing or differing thicknesses and/or dimensions of the resilient material or the base element.

The motion support mechanism as herein described may be applied to other seating devices, such as dentists' chairs, lab stools, car seats, gaming chairs, leisure chairs such as bar stools, amusement park rides, children's school stools and similar devices where it would be beneficial to provide resistive support to a user. Other applications include devices meant to support a user in a standing position, such as construction support surfaces or pedestals. In the case of a dental hygienist using a hygienist's chair, for example, while the user reaches to perform their tasks, the free movement of the seat by way of the motion support mechanism prevents an acceleration of forces through the lower lumbar region of the user thereby reducing the potential of strains associated with this movement, which contributes to user pain and injury that may be experienced while sitting on a fixed level seating surface.

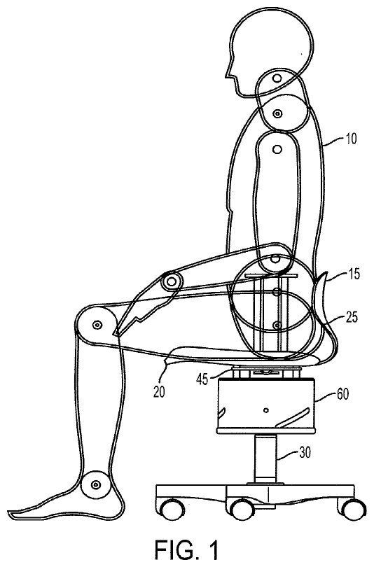

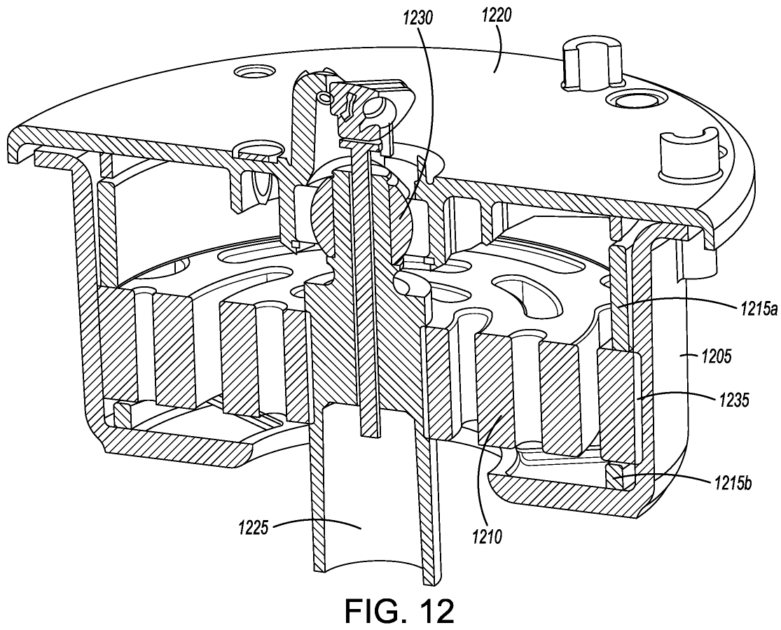

FIG. 1 to FIG. 11 illustrate the general working principles of state-of-the-art resistive support mechanisms and their implementation. FIG. 12 illustrates a preferred embodiment of the resistive support mechanism according to the present invention. The mechanism of FIG. 12 may be implemented, incorporated into or otherwise used with the embodiments of FIG. 1 to FIG. 11.

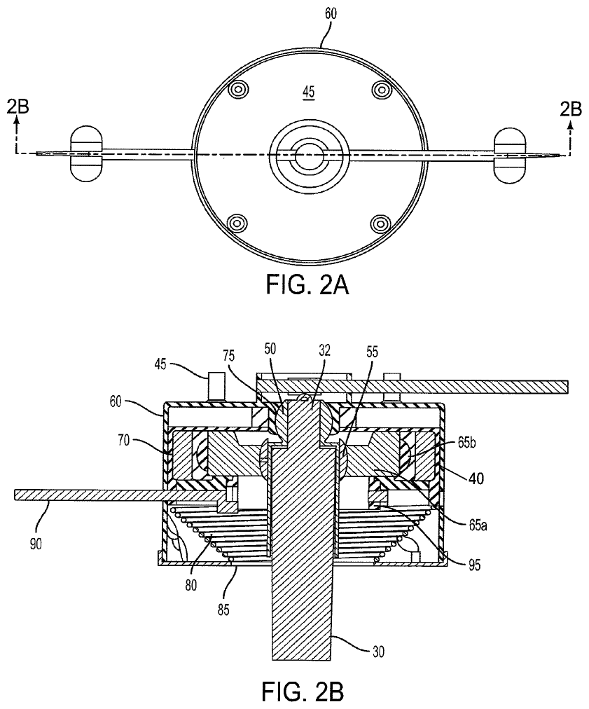

Referring now to FIG. 1, there is shown a user 10 seated on a chair 15. Chair 15 may include a seat portion 20, a backrest 25, a base 30, and a resistive support mechanism 40 (not shown in FIG. 1), within housing 60 according to the invention. An interface 45 is provided on the housing 60 and between the seat portion 20 for attaching the seat thereto. FIG. 2A shows a top view of the housing 60 and interface 45. Interface 45 is adapted to mount the seat of the chair thereon, and is alternatively referred to herein as a mounting surface. Chair 15 may further include various other elements known in the art, including but not limited to height adjustment mechanisms, arm rests, and various other adjustment devices that are otherwise unrelated to the resistive support mechanism as herein described. For clarity, in the description that follows, reference to a vertical axis refers to an axis coincidental with the cylindrical axis of the base 30. Reference to a horizontal axis refers to an axis perpendicular to the vertical axis. Furthermore, references to tilt and/or rotational motion have their ordinary meaning, wherein tilt motion refers to rotation about the horizontal axis and rotational motion refers to rotation about the vertical axis. The description further describes elements of the invention required to put the invention into practice and further sets forth a preferred embodiment as contemplated by the invention. However, various hardware and ordinary mechanical elements that would be used to assemble a mechanism or chair according to the invention may not be described and are considered within the abilities of a person skilled in the art.

Referring to FIG. 2B, there is shown one embodiment of the resistive support mechanism according to the invention, including a support bearing 50 connected to the mounting surface 45 and to the base 30. Support bearing 50 permits one or both of tilting and rotational-motion of the mounting surface 45 relative to the base 30. Base 30 may include a shoulder portion 32 that is friction fit into the support bearing 50, such that base 30 does not move relative to the support bearing 50. Mounting surface 45 is free to tilt or -rotate with respect to the support bearing 50 such that support bearing 50 permits one or more of rotational or tilt movement of the mounting surface 45 relative to the base 30. A housing 60 is the main body of support for the mounting surface 45, which preferably includes stand-offs to fasten a seating surface to the mechanism is preferably provided to contain within it all or most of the elements of the resistive support mechanism. Preferably, the housing 60 also includes a bearing surface 75 for receiving at least a portion of the support bearing 50. The surfaces of support bearing 50 and bearing surface 75 will be provided such that minimal frictional forces are present between these surfaces so that movement on the support bearing 50 is relatively uninhibited. Housing 60 preferably extends directly from mounting surface 45 and is formed unitarily therewith. The functioning of bearings and bearing surfaces is generally known in the art and not further described herein. The invention also contemplates the use of functional alternatives to bearings and bearing surfaces that provide for the full two-degrees of freedom of movement made possible by support bearing 50 and bearing surface 75.

A pivot ball 55 is positioned on a portion of the base 30. As will be described below, pivot ball 55 has a resistive force providing means acting on it to provide the resistive support to the mechanism. Various ways of implementing the resistive force providing means are contemplated. The resistive force providing means is preferably implemented by way of a resistance cartridge 40 that acts on the pivot ball 55. In this manner, the resistive and/or dampening forces are exerted perpendicular to the vertical plane of the mounting surface 45 resulting in a more stable and controlled ride compared to prior art devices. For example, the aforementioned Thole patent allows the resilient material as therein arranged to undergo various compression and torque forces resulting in various compression and torque forces being applied to the resilient material.

In the embodiment of FIG. 2B, a resistance cartridge 40 is fixedly connected to the mounting surface 45 in a manner that allows the resistance cartridge 40 to undergo tilt and/or rotational-movement relative to the base 30 and to apply a resistive force on the base 30 as the resistance cartridge 40 and therefore the mounting surface 45 undergoes relative movement with respect to the base 30. The resistance cartridge 40, provides the core functionality of the resistive support mechanism of the invention. In this embodiment, the resistance cartridge 40 includes therein resilient member 65b, pivot ball 55, and cartridge housing having a wall 70. The resilient member 65b is arranged in contact relation with the pivot ball 55, via extension member 65a, and with a wall 70 of the cartridge housing of the resistive cartridge 40 such that, in operation, the resilient member 65 is compressed by the relative movement between the resistance cartridge 40 and the pivot ball 55. Preferably, pivot ball 55 has a snug but sliding interface with extension member 65a. When the mounting surface 45 is tilted, the resilient material 65b is compressed between the wall 70 and the extension member 65a. Preferably, extension member 65a is formed from a rigid material that forms a ring around the pivot ball 55 and extends radially outward there form towards the wall 70. The sliding interface between the extension member 65a and the pivot ball 55 allows the entire mounting surface 45 to tilt while the resilient member 65b provides a dampening feature that prevents the mounting surface 45 from unrestrained movement, and permits smooth movement over the maximum range of motion to thereby provide the resistive support to the mounting surface 45, and any object attached thereto, such as seat 20 (of FIG. 1).

The resilient member 65b is preferably selected from the group consisting of an elastomeric ring, silicone, a gel, a series of rubber elements, and any similar materials know to have damping characteristics or otherwise able to resist relative movement when compressed or otherwise subjected to a force. It is also contemplated that a combination of resilient members may be employed to vary the resistance being applied across the range of motion available. For example, the resilient member 65b may include a first resilient member in contact relation with the extension element 65a and a second resilient member in contact relation with the wall 70. In a preferred embodiment of the invention, the resilient member 65b is a viscoelastomeric material bonded to the wall 70 and to the extension element 65a. The use of a viscoelastomeric material provides a damping effect where the material deforms, absorbs and distributes more of the load as it is compressed and slowly recovers when the load is removed. The result is that when the resistive support mechanism 40 is returning to a home position, the movement back to the home position is dampened and controlled based on the material properties. The use of a viscoelastomeric material allows the rate of resistance to be accentuated such that the flow properties of the resilient member are more prominent, thus providing for increased dampening. That is, viscoelastomeric materials have a response that exhibits both viscous and elastic properties when a load is applied and therefore hysteresis is observed.

Wall 70 of the resistance cartridge 40 includes an outer surface that is capable of sliding vertically within the housing 60 to thereby permit the resistance cartridge 40 to have its vertical position adjusted within the housing 60, as will be described in further detail below. In a preferred embodiment, the resilient member 65b is a viscoelastomeric ring, and the extension element 65a is a rigid material in a ring shape articulating with the pivot ball and radiating outward to compresses the resilient member 65b having damping properties. It is also contemplated that the second resilient member may be provided that includes a plurality of gels in contact with each other and/or the leading edge of the extension member 65a. Where a plurality of gels are included, it is preferably that the gels further away from the pivot ball 55 will have a higher density than those gels closer to the pivot ball 55, although variations of this are considered within the scope of the invention. This permits the resistance to tilting to be greater as the degree of tilt increases.

Furthermore, the provision of the resilient members 65 as herein described allows the mounting surface 45, and the seat 20 mounted thereon, to be biased towards a home position, having no tilt or rotational due to pre-compression of the resilient members 65. Thus, if a user seated in the chair leans in one direction and is supported there by the resistive support mechanism as described, but subsequently stands up, the seat will return to an unbiased home position.

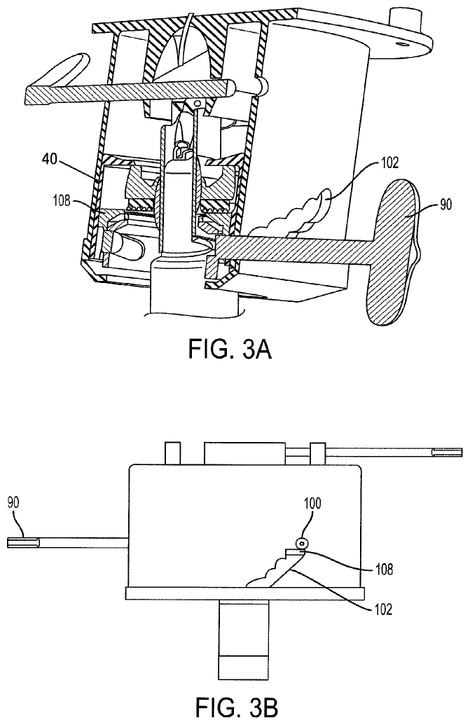

According to an aspect of the invention, a means for varying the resistive force acting on the pivot ball 55 is provided. This allows the resistance applied by the resistive cartridge to be increased or decreased depending on, for example, the intended use of the resistive support mechanism or the user. In the case of a chair, a larger user may require a higher resistive force than a small sized user. In addition, regardless of size, the user may wish to have more or less resistance, which will allow them the possibility of more recruitment of core musculature to affect an exercise phenomena, and opportunity to mobilize the joints of their pelvis and vertebral regions and or a reduction of forces experienced on the sitting support soft tissue and joints in question when the user may otherwise be required to make repetitive movements as may be best illustrated by the work of a dental hygienist as an example. In the illustrated embodiment of FIG. 2B, the means for varying the resistive force includes a spring 80 compressed between a bottom surface 85 of the housing 60 and an underside 95 of the resistance cartridge 40. In order to vary the force applied to thereby vary the resistive force in the resistance cartridge, a resistance lever 90, functionally attached to an interface plate 95 is preferably provided. The resistance lever 90 is adapted to be moveable to vary the position of the interface plate 95 under urging of the spring 80, and thereby to vary the position of the resistive cartridge 40 with respect to the base 30. As will be appreciated by a person skilled in the art, the position of the resistance cartridge 40 with respect to the base 30, that is, how far up the base 30 the resistance cartridge 40 acts, is determinative of the effective resistive force applied by the resistance cartridge 40, since the point of tilt/rotational is fixed. That is, the effective distance between the pivot ball 55 and the support bearing 50 is determinative of the resistive force applied by the resistance cartridge 40. Referring to FIGS. 3A and 3B, spring 80 (not shown for ease of illustration) is used to bias the underside 95 of the resistance cartridge 40 and all parts internal thereto, within housing 60, to an uppermost vertical position, as would be dictated by the position of the lock pin 100, within helix 102. In this embodiment, the position of pin 100, along the steps of helix 102, may be set by adjusting saddle 108 by moving resistance lever 90 within the steps of the helix 102. It should be noted that helix 102 is provided on both sides of the resistance cartridge 40, with one side including steps within which to move the lever 90 and the other side include corresponding steps within which pin 100 is provided to fix the other side within a corresponding step. It will be appreciated by a person skilled in the art that there is greater resistance in the system when the pin 100 is at a lower step within the helix 102, since the resistance cartridge 40 is further away from the point of rotation/tilt.

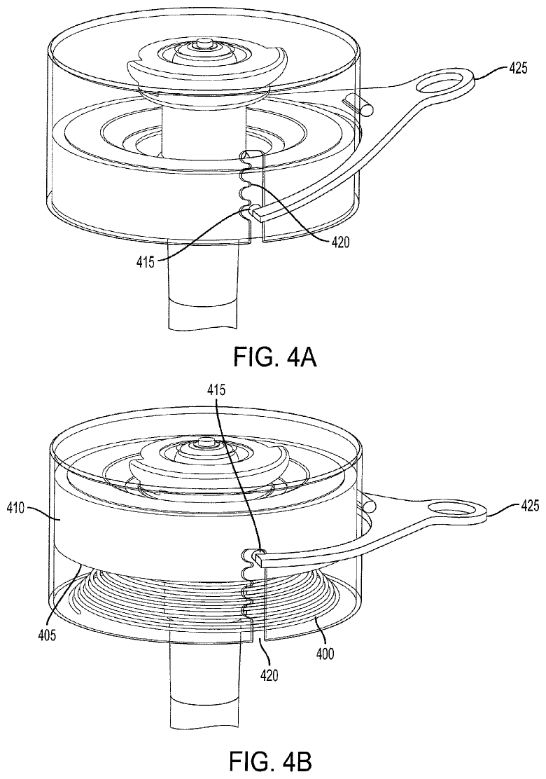

Various other implementations and embodiments of the invention are described below, however, the principle of operation in that there is a support bearing and a pivot ball provided as described above. Furthermore, there is preferably provided a means for varying the resistive force by varying the distance between the pivot ball on which the resilient material acts, and the support bearing. Referring now to FIGS. 4A and 4B, there is shown a variation of the means for varying the resistive force in which a spring 400 acts on an underside 405 of the cartridge housing 410 to bias the cartridge housing 410 to an uppermost position in a similar manner as described with respect to FIG. 3. In this embodiment, however, the height of the cartridge housing is limited by the position of lever stops 415 within the series of steps 420. Lever 425 is moveable such that lever stops 415 may be brought to rest on a desired step 420. Accordingly, spring 400 exerts an upwards force on the resistance cartridge 440 such that resistance cartridge 440 is positioned at a location limited by the particular step in the series of steps 420 in which the lever stops 415 are positioned.

According to another aspect of the invention, a means for locking the resistance cartridge 40 at any position in which the mounting surface 45 has undergone movement relative to the base is also provided. Such a locking means provides the benefit of allowing the seat, or other apparatus mounted on the mounting surface 45 to be locked in position, and to therefore prevent the mechanism from returning to its home position. The different embodiments of the means for locking herein described permit locking in either predetermined incremental positions, or at a free floating position. The inclusion of a means for locking may be of particular benefit where the resistive support mechanism is deployed in environments where it may not always be beneficial for the resistive functionality to be active, or in the alternative, to provide additional functionality whereby the mechanism may be locked at any position of tilt or rotation-during use.

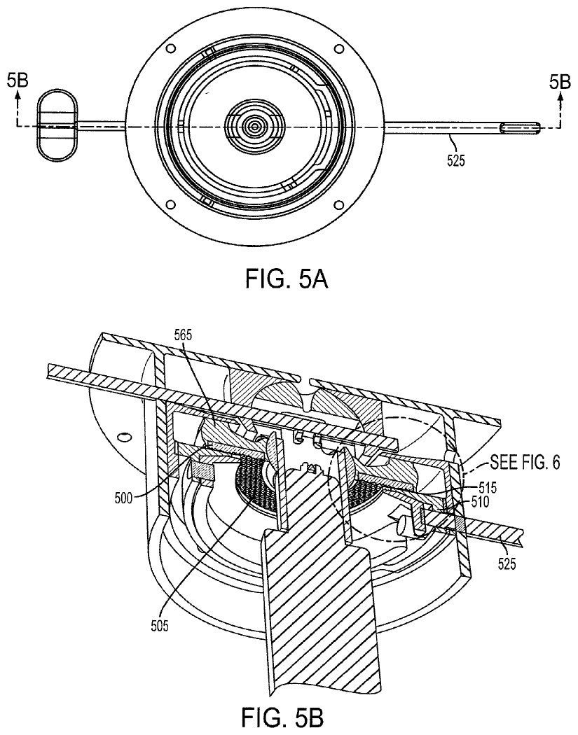

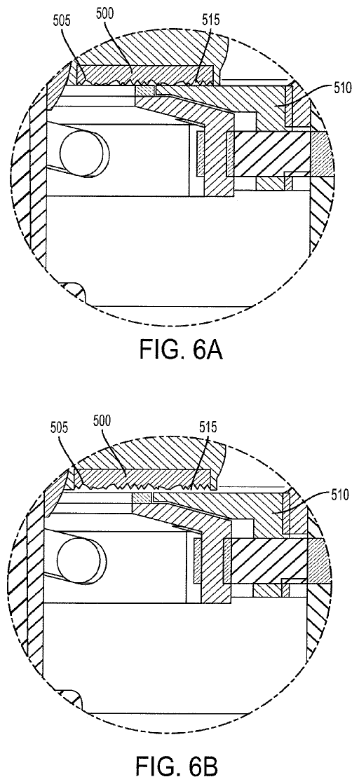

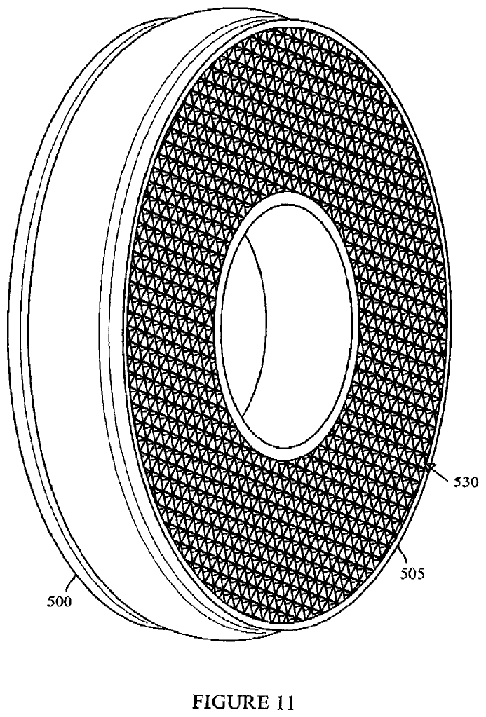

Referring to FIGS. 5A, 5B and 6A, 6B, there is shown an embodiment of the locking means according to the invention. The resistive support mechanism of this embodiment includes, within the resistive cartridge, a rigid plate 500 positioned at underside of the extension member 565. The rigid plate 500 has a surface having a plurality of locking elements 505 on a surface distal to the contact surface with the extension member 565. In order to lock the resistive support mechanism in position, a locking pad 510 having a surface of complimentary locking elements 535 is provided and adapted to be brought into contact with the plurality of locking elements 505, 515 of the rigid plate 500. When the locking elements 505, 515 are engaged with the complimentary locking elements 535, further tilt and/or rotational motion is prevented. An exemplary embodiment of the rigid plate 500 having the plurality of locking elements 505, 515 is shown in FIG. 11. In the illustrated embodiment, the plurality of locking elements 505 is provided by a knurled surface 530 on an underside of the rigid plate, as illustrated.

Other locking means contemplated include systems similar to bicycle disk brakes, multi-layer compression plates and rotors and pads, all of which may be applied to the invention in a manner analogous to the Preferably, the locking means of the invention is capable of being activated in either predetermined increments or at random engagement points as will be possible in the various embodiments described herein.

Referring back to FIG. 5B, a brake lever 525 is provided that is adapted to raise and lower the locking pad 510, for example, by way of a twist motion that activates a cam mechanism to thereby bring the complementary locking elements 535 of the locking pad 510 into and out of contact with the knurled surface 530 of the rigid plate 500.

Having thus described a presently preferred embodiment of the invention, including the resistance cartridge, and optional means for varying the resistance and for locking the motion support mechanism in a particular position, various alternatives will now be described. Specifically, the alternatives relate to alternate means for varying the resistance and/or for locking the motion support mechanism. It will be understood by those skilled in the art that the invention is not limited to particular combinations of the embodiments of the resistance cartridge, means for varying the resistance and means for locking in the combinations as described. Combinations of the resistance cartridge, means for varying the resistance, and means for locking that are herein described are contemplated by the invention, which is only limited by the claims at the end of the specification. In the description that follows, elements common to the description above are not described in further detail, and their operation will be apparent to a person skilled in the art, having regard thereto.

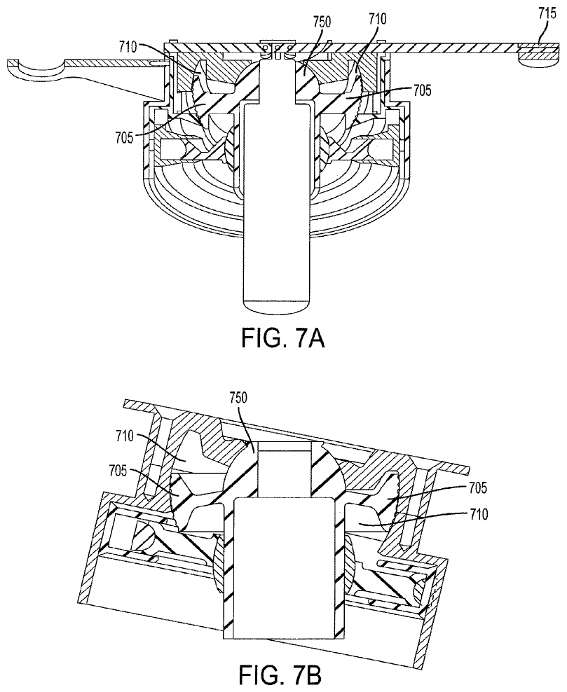

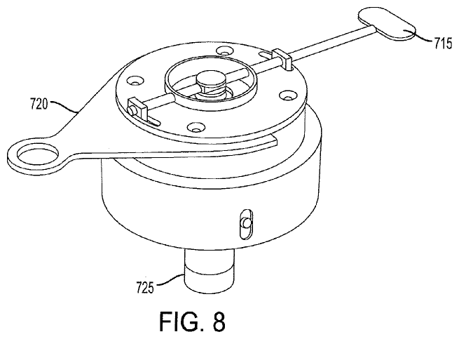

Referring now to FIGS. 7A and 7B, there is shown an embodiment of the invention in which a support bearing 750 includes one, and preferably two bearing protrusions 705. The resistance cartridge preferably includes corresponding locking surfaces 710 that provide a region of contact with the bearing protrusions 705 that is adapted to be brought into a friction fit contact relationship with the protrusions 705 when a means for locking is activated. In order to activate the lock, an adjustment lever 715 is provided to displace the resistance cartridge to a position in which its motion is locked. The adjustment lever 715 is adapted to apply a rotational motion by rotating the bearing protrusions 705 into contact relationship with the locking surfaces 710. FIG. 8 shows a resistance cartridge according to this embodiment. Lever 715 may be rotated about a generally horizontal axis to permit the lever 715 to move, and then may be rotated about a generally horizontal axis to engage the locking features as described above. In this manner, the locking mechanism, that is the lever 715, may be activated and deactivated as required by a user by rotation about the horizontal axis, and may be used to effect locking by rotation about the vertical axis. Also shown in FIG. 8, is a force adjustment lever 720 for raising or lowering the resistance cartridge to alter the portion of the base 725 on which the resistance cartridge acts to vary the resistive forces in the motion support mechanism, as has been described above. In practice, a locking means as described and illustrated with respect to FIGS. 7 and 8 may have a maximum range of tilt around the support bearing of approximately +/−fourteen degrees.

It has been discovered that adapting the resistive support mechanism according to the invention to have a range of tilt of approximately fourteen degrees allows for the effective mobilization of the joints involved to optimize the range of motion and to ensure a reasonable limit for safety considerations.

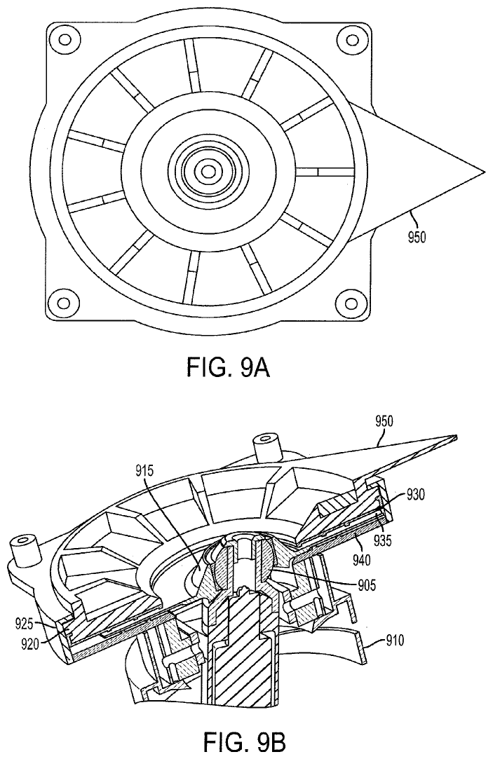

Referring now to FIGS. 9A and 9B, there is shown another embodiment of a locking means according to the invention. The locking means of FIGS. 9A and 9B includes a lock rotational ball 905 positioned above the resistance cartridge 910. The lock rotational ball 905 is generally provided as herein described as a rotational ball about which the motion support mechanism of the invention is able to tilt and/or rotate. A lower lock surface disc 915 is provided in such a manner so as to be brought into frictional contact with the lock rotational ball 905. This is generally accomplished by raising or lowering the lock body 920 into and out of contact with the housing body 925 to provide an offsetting distance between the lock body 920 and the housing body 925. This movement also transfers the load onto lock surfaces 930 on an underside of the lock body 935 on a topside 940 of the rotational disk 915. The surfaces 930 and 940 have concentric ridges to provide for additional locking force. These surfaces may include a rubber gripping layer that is deformed when the surfaces are brought into contact to provide for the additional locking. A lock lever 950 is provided to engage and disengage the lock. This can be accomplished, for example, by allowing the lock lever 950 to be rotated about the vertical axis such that such rotation causes the lock body 920 to be displaced vertically to engage or disengage the lock.

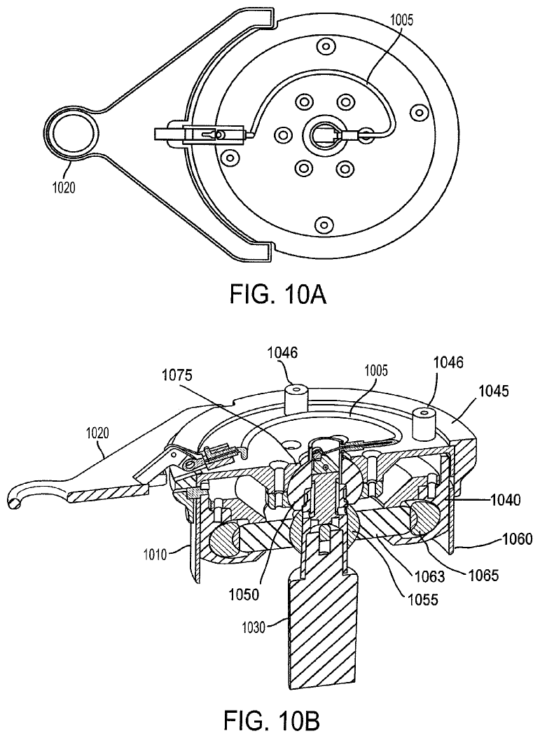

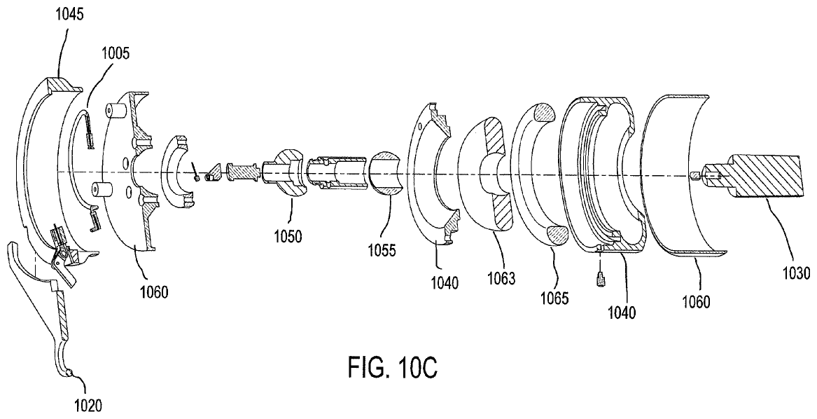

Referring to FIGS. 10A, 10B and 10C, there is shown another embodiment of the invention including a support bearing 1050 connected to the mounting surface 1045 and to the base 1030. Support bearing 1050 permits one or both of tilting and rotational motion of the mounting surface 1045 relative to the base 1030. Base 1030 does not move relative to the support bearing 1050. Mounting surface 1045 is accordingly free to tilt or rotate with respect to the support bearing 1050 such that support bearing 1050 permits one or more of rotational and tilt movement of the mounting surface 1045 relative to the base 1030. A housing 1060 having mounting surface 1045, which may include stand offs 1046 to fasten a seating surface to the mechanism, extending therefrom is preferably provided to contain within it all or most of the elements of the resistive support mechanism within the resistance cartridge 1040. Preferably, the housing 1060 also includes a bearing surface 1075 for receiving at least a portion of the support bearing 1050.

A pivot ball 1055, within resistance cartridge 1040, is positioned on a portion of the base 1030. As described with respect to previous embodiments of the invention, the resistance applied is varied by permitting the distance between the pivot ball 1055 and the support bearing 1050 to be varied, by adjusting the position on the base 1030 on which the pivot ball 1055 acts. Extension element 1063 is a rigid element extending from the pivot ball 1055 on which resilient member 1065 acts. As illustrated, resilient member 1065 is compressed between the extension element 1063 and a wall of the resistance cartridge 1040 to provide the resistance to tilt and/or rotation.

In this embodiment, there is provided a cable 1005 adapted to raise or lower the position of seat, or other surface atop the mounting surface that is being subject to resistive motion of the resistance cartridge 1010 with respect to the base 1015. The cable 1005 may be drawn by activation of the lever 1020 by rotation about the vertical axis. The cable 1005 may be provided within a cable tube, as illustrated, to prevent damage to the cable. According to the invention, rotation of the lever 1020 about the vertical axis releases and dispenses a length of the cable 1005 to activate an air cylinder atop the base 1015, which results in the cylinder being moved up or down. Various other hardware elements are illustrated, but not described as these are provided for facilitating installation or have been described with respect to previous embodiments of the invention.

Referring now to FIG. 12, there is shown a resistive support mechanism 1200 in accordance with the invention in which the adjustable resistance cartridge as described above is substituted for a fixed resistance cartridge 1205 that may adjust the resistance by either increasing or decreasing the durometer of the rubber making up the resistance ring, or bushing 1210. The mechanism includes a mounting surface 1220 which may be substantially as described above and a base shaft 1225 with a cartridge therebetween. The cartridge includes a support bearing 1230, substantially as herein described, connecting to the mounting surface 1220 and to the base shaft 1225 which permits one or both of rotational and tile movement of the mounting surface 1220 relative to the base shaft 1225. Base shaft 1225 is typically a shaft connecting the mounting surface 1220 to the bottom of the seating surface. The support bearing 1230 may be formed integrally with the base shaft 1225. A resistance ring 1210 is fixedly connected to the mounting surface such that the resistance ring 1210 undergoes movement relative to the base shaft and applies a resistive force on the base shaft as the mounting surface 1220 undergoes one or both of rotational and tilt movement.

As herein described, a resistive means for varying the resistive force that the resisting ring 1210 places on the base shaft is also provided. In this embodiment, the resistive means is a fixed system with no moving parts was the resistive support mechanism is in use. The resistive means includes the aforementioned resistance ring 1210 in contact relation with the base shaft 1225 and with a wall 1230 of housing 1235 such that the resistance ring 1210 is compressed by the relative movement between the housing 1235 and the base shaft 1220 to thereby provide resistive support to the mounting surface 1220.

In the illustrated embodiment, spacer 1215 holds the resistance ring at a defined moment arm from a top pivot and allows the internal portion of the resistance ring 1210 that comes into contact with the shaft to have vertical movement. By adjusting the distance between the mounting surface 1220 and the resistance ring 1210, the spacer 1215 applies a downward force onto the resistance ring 1210 thereby applying a greater force onto the resistance ring 1210 and changing the resistive force the resistance ring 1210 places on the base shaft 1225.

In use, as the mounting surface 1220 is raised or lowered by way of a shaft or gas lift (as is typical for adjustable chairs), the spacer 1215 applies a decreasing or increasing force onto the resistance ring 1210 thereby changing the resistance to rotation or tile that the resistance ring 1210 applies onto the base shaft 1225. The mounting surface is moveable from an uppermost to a lowermost position, such that the spacer extending from an underside of the mounting surface to an upper surface of said resilient ring applies a minimum force at the uppermost position and a minimum force at the lowermost position. The minimum force could be a null force.

Resistance ring 1210 may be substantially similar to the resilient member herein described and may consist of an elastomer, a silicone, a dampening gel, a viscoelastomer, a bonded dampening material or a combination of any of the above.

The invention also includes a method for varying the resistance in a resistive motion support mechanism, the resistive motion support mechanism as herein described; the method comprising imparting a force onto said resilient ring thereby changing its resiliency.

The above-described embodiments are intended to be examples of the present invention and alterations and modifications may be effected thereto, by those of skill in the art, without departing from the scope of the invention that is defined solely by the claims appended hereto. For example, various materials may be used in providing the elastomeric ring or gels in the resistance cartridge described above. Furthermore, other means of providing the damping and/or resistive properties other than by way of such materials are also contemplated, for example, springs. Furthermore, other means for varying the resistance applied are also contemplated. The presently preferred embodiments as herein described are to be considered illustrative of applicant's invention. Similarly, other means for locking the support mechanism of the invention are also contemplated.

It has also been discovered that the positioning of the support bearing of the invention being immediately beneath and close to the user's centre of mass provides the unexpected benefit of more acutely affecting the mobilization of the user's joints compared to prior art mechanisms. Prior art active sitting solutions have pivot points further from the user, resulting more in a lean of the entire body of the user rather than a mobilization of critical joints.

1. A resistive motion support mechanism joined to a mounting surface and to a base shaft for providing resistive support to the mounting surface as the mounting surface undergoes one or both of rotational and tilt movement relative to the base, the motion support mechanism comprising:
a support bearing connected to the mounting surface and to the base shaft which permits one or both of tilting and rotational motion of the mounting surface relative to the base;
a pivot ball functionally attached to a portion of the base shaft;
a resilient ring within a housing circumscribing said base shaft such that said resilient member is compressed between said housing and said base shaft by the relative movement between said base shaft and said mounting surface to provide a resistive force on the base shaft to resist said one or both of rotational and tilt movement; and,
a means for varying said resistive force.

2. The resistive motion support mechanism of claim 1, wherein said means for varying said resistive force operates by imparting a force onto said resilient ring thereby changing its resiliency

3. The resistive motion support mechanism of claim 1, wherein said mounting surface is moveable from an uppermost to a lowermost positions; and said means for varying said resistive force includes at least one spacer extending from an underside of the mounting surface to an upper surface of said resilient ring such that at said uppermost position the spacer applies a minimum force on said resilient ring and at said lowermost position, said spacer applies a maximum force on said resilient ring.

4. The resistive motion support mechanism of claim 2, wherein said minimum force is no force.

5. The resistive motion support mechanism of claim 2, further including a second spacer extending from a lower surface of said resilient ring to a base surface of the housing.

6. The resistive support mechanism of claim 1, wherein said resilient ring comprises a plurality of internal deformation gaps where material is removed from the resilient ring to facilitate compression of the resilient ring towards the base shaft.

7. The resistive support mechanism of claim 1, wherein said resilient ring comprises a material selected from the group comprising an elastomer, a silicone, a dampening gel, a viscoelastomer, a bonded dampening material and a combination of same.

8. The resistive support mechanism of claim 1, wherein said resilient member is adapted to bias said mounting surface to a home position.

9. The resistive support mechanism of claim 1, further comprising a rigid plate connected proximate to an underside of said resilient member, wherein said rigid plate has a surface having a plurality of locking elements on a surface distal to said resilient member, and wherein said means for locking comprises a locking pad having a surface of complimentary locking elements adapted to be brought into contact with said plurality of locking elements on said rigid plate.

10. (canceled)

11. A method for varying the resistance in a resistive motion support mechanism, the resistive motion support mechanism including a resilient ring within a housing circumscribing a base shaft such that said resilient member is compressed between said housing and said base shaft by the relative movement between the base shaft and a mounting surface to provide a resistive force on the base shaft to resist one or both of rotational and tilt movement; the method comprising imparting a force onto said resilient ring thereby changing its resiliency.

12. The method of claim 10 wherein imparting a force comprises moving a mounting surface from an uppermost to a lowermost position, such that the movement of the mounting surface applies a force onto a spacer which compresses the resilient ring.

13. The method of claim 11, wherein the spacer extends from an underside of the mounting surface to an upper surface of said resilient ring such that at said uppermost position the spacer applies a minimum force on said resilient ring and at said lowermost position, said spacer applies a maximum force on said resilient ring.

14. The method of claim 12, wherein said minimum force is no force.

15. The method of claim 10, wherein said resilient ring comprises a plurality of internal deformation gaps where material is removed from the resilient ring to facilitate compression of the resilient ring towards the base shaft.

16. The method of claim 1, wherein said resilient ring comprises a material selected from the group comprising an elastomer, a silicone, a dampening gel, a viscoelastomer, a bonded dampening material and a combination of same.

17. A method for varying the resistance in a resistive motion support mechanism, the resistive motion support mechanism including a resilient ring within a housing circumscribing a base shaft such that said resilient member is compressed between said housing and said base shaft by the relative movement between the base shaft and a mounting surface to provide a resistive force on the base shaft to resist one or both of rotational and tilt movement; the method comprising the addition, removal or varying dimensions of at least one spacer.
